(19) United States
(12) Patent Application Publication
(10) Pub. No.: US 2026/0155283 A1
(43) Pub. Date: Jun. 4, 2026

(54) SINTERED NEODYMIUM-IRON-BORON MAGNET WITH HIGH CORROSION RESISTANCE AND HIGH MAGNETIC PERFORMANCE, AND PREPARATION METHOD THEREFOR

(71) Applicants: NANTONG ZHENGHAI MAGNET CO., LTD., Nantong, Jiangsu (CN); YANTAI ZHENGHAI MAGNETIC MATERIAL CO., LTD., Yantai, Shandong (CN)

(72) Inventors: Zhaopu XU, Yantai, Shandong (CN); Yumeng ZHANG, Yantai, Shandong (CN); Jiliang WANG, Yantai, Shandong (CN); Jiling ZHAO, Yantai, Shandong (CN); Nan ZHAO, Yantai, Shandong (CN)

(21) Appl. No.: 18/706,944

(22) PCT Filed: Sep. 1, 2023
(86) PCT No.: PCT/CN2023/116478

§ 371 Date: May 2, 2024

(30) Foreign Application Priority Data
Sep. 8, 2022 (CN) 202211098344.1

(51) Int. Cl. H01F 1/057; B22F 3/24; C22C 38/00; C22C 38/06; C22C 38/10; C22C 38/14; C22C 38/16; H01F 41/02

(52) U.S. Cl. CPC H01F 1/0571; B22F 3/24; C22C 38/002; C22C 38/005; C22C 38/06; C22C 38/10; C22C 38/14; C22C 38/16; H01F 41/0266; B22F 2201/10; B22F 2201/20; B22F 2301/355; B22F 2998/10; C22C 2202/02

(57) ABSTRACT

A sintered neodymium-iron-boron magnet with corrosion resistance and high magnetic performance, and a preparation method therefor are presented. The sintered neodymium-iron-boron magnet comprises Co at a content of 1.5-3.0 wt %, and comprises a main phase and a grain boundary phase, wherein Co is distributed in the grain boundary phase of crystalline grains and the main phase of crystalline grains. The sintered neodymium-iron-boron magnet satisfies: w1≥w2, wherein w1 is the content of Co distributed in the grain boundary phase of the crystalline grains, and w2 is the content of Co distributed in the main phase of the crystalline grains.

The present application claims priority to the prior application with the application No. 2022110983441 entitled “SINTERED NEODYMIUM-IRON-BORON MAGNET WITH HIGH CORROSION RESISTANCE AND HIGH MAGNETIC PERFORMANCE AND PREPARATION METHOD THEREFOR” and filed with the China National Intellectual Property Administration on Sep. 8, 2022, which is incorporated herein by reference in its entirety.

### TECHNICAL FIELD

The present disclosure relates to the technical field of NdFeB-based sintered magnets, and in particular to a sintered neodymium-iron-boron magnet having a high corrosion resistance and high magnetic performance and a preparation method thereof.

### BACKGROUND

Since the discovery of the neodymium-iron-boron material, it has been widely applied to the fields of communication, medical treatment, automobiles, electronics, aviation, and the like due to its excellent magnetic performance and high cost performance, becoming an ideal material for manufacturing magnetic functional materials with high efficiency, small volume, and light mass, and exerting revolutionary influence on a plurality of application fields. However, the temperature stability of the neodymium-iron-boron material is poor, and the main components of the neodymium-iron-boron material comprise a high level of rare earth elements, so the corrosion resistance of the neodymium-iron-boron material is poor. These two types of problems greatly limit the expansion of the application scope of the neodymium-iron-boron material.

In the prior art, in order to improve the corrosion resistance of the neodymium-iron-boron material, the element Co is usually added into the neodymium-iron-boron material, and the more the element Co is added, the better the corrosion resistance of the neodymium-iron-boron material is. However, when the addition amount of the element Co is increased to not less than 3 wt %, the magnetic performance of the neodymium-iron-boron material will be affected. This ultimately makes it infeasible to improve the corrosion resistance of the neodymium-iron-boron material by adding element Co while maintaining the high magnetic performance of the neodymium-iron-boron material.

### SUMMARY

After conducting extensive studies on the problems described above, the inventors of the present disclosure found that after adding element Co to the neodymium-iron-boron magnet, most of the element Co is distributed in the main phase of grains, and a small portion of the element Co is distributed in the grain boundary phase of grains. The element Co distributed in the grain boundary phase of grains plays a major role in improving corrosion resistance and magnetic performance of a neodymium-iron-boron magnet. However, when the element Co is continuously added to increase the content of the element Co in the grain boundary phase, the neodymium-iron-boron magnet shows a reduced magnetic performance. Based on analysis, the inventors believe that this is because the content of the element Co in the grain boundary phase of grains increases while the content of the element Co in the main phase of grains increases more due to the continuous addition of the element Co, resulting in a decrease of magnetic performance of the neodymium-iron-boron magnet.

In order to remedy the defects of the prior art, the present disclosure provides a sintered neodymium-iron-boron magnet having high corrosion resistance and high magnetic performance and a preparation method therefor. The sintered neodymium-iron-boron magnet comprises an element Co with a content of 1.5-3.0 wt %, wherein the element Co is distributed in a grain boundary phase and a main phase of grains, and the content of the element Co distributed in the grain boundary phase of grains is greater than or equal to the content of the element Co distributed in the main phase of grains. As the element Co in a sintered neodymium-iron-boron magnet is mainly concentrated in the grain boundary phase, the corrosion resistance and magnetic performance of the sintered neodymium-iron-boron magnet can be significantly improved.

The present disclosure provides the following technical solutions:

Disclosed is a sintered neodymium-iron-boron magnet comprising an element Co with a content of 1.5-3.0 wt % and comprising a main phase and a grain boundary phase, wherein the element Co is distributed in the grain boundary phase and the main phase of grains, and the sintered neodymium-iron-boron magnet satisfies the following formula: w1≥w2, wherein w1 is the content of the element Co distributed in the grain boundary phase of grains, and w2 is the content of the element Co distributed in the main phase of grains.

In the present disclosure, unless otherwise specifically defined, the contents are all based on mass percentage.

According to an embodiment of the present disclosure, the content w1 of the element Co distributed in the grain boundary phase of grains is greater than the average content of the element Co in the sintered neodymium-iron-boron magnet. The content w2 of the element Co distributed in the main phase of grains is less than the average content of the element Co in the sintered neodymium-iron-boron magnet.

According to an embodiment of the present disclosure, the sintered neodymium-iron-boron magnet satisfies the following formula: w1≥1.5×w2, wherein w1 is the content of the element Co distributed in the grain boundary phase of grains, and w2 is the content of the element Co distributed in the main phase of grains.

According to an embodiment of the present disclosure, the distribution of the element Co in the main phase and the grain boundary phase at any position (such as the surface and the center) of the sintered neodymium-iron-boron magnet is configured to satisfy the formula of w1≥w2, preferably the formula of w1≥1.5×w2.

According to an embodiment of the present disclosure, in the sintered neodymium-iron-boron magnet, a Co-rich region in the grain boundary phase does not completely overlap with a region enriched in heavy rare earths.

According to an embodiment of the present disclosure, in the sintered neodymium-iron-boron magnet, the Co-rich region in the grain boundary phase is a Fe-poor region.

According to an embodiment of the present disclosure, in the sintered neodymium-iron-boron magnet, the grain boundary phase contains a phase consisting of RFeCOM, wherein R is a rare earth element, Fe is iron, Co is cobalt, and M is one or more of Ga, Cu, Al, Zr, and Ti.

According to an embodiment of the present disclosure, in the sintered neodymium-iron-boron magnet, the content of the R element in the grain boundary phase is greater than or equal to the content of the R element in the main phase.

According to an embodiment of the present disclosure, in the sintered neodymium-iron-boron magnet, the content of the M element in the grain boundary phase is greater than or equal to the content of the M element in the main phase.

According to an embodiment of the present disclosure, in the sintered neodymium-iron-boron magnet, the content of the Fe element in the grain boundary phase is less than or equal to the content of the Fe element in the main phase.

According to an embodiment of the present disclosure, the sintered neodymium-iron-boron magnet comprises an element Co with a content of 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, or 3.0 wt %.

According to an embodiment of the present disclosure, the sintered neodymium-iron-boron magnet has a chemical formula of RFeCoBM, wherein R is a rare earth element, Fe is iron, B is boron, and M is one or more of Ga, Cu, Al, Zr, and Ti, wherein the content of R is 26-35 wt %, the content of B is 0.8-1.3 wt %, the content of Co is 1.5-3.0 wt %, the content of Ga is 0.05-0.5 wt %, the content of Cu is 0.05-0.6 wt %, the content of Al is 0-1.5 wt %, the content of Zr is 0-0.5 wt %, the content of Ti is 0-0.5 wt %, and the rest is iron and inevitable impurities.

According to an embodiment of the present disclosure, R is a rare earth element, e.g., at least one of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), and scandium (Sc).

According to an embodiment of the present disclosure, in the sintered neodymium-iron-boron magnet, the content of C element is less than or equal to 800 ppm; the content of O element is less than or equal to 800 ppm; and the content of N element is less than or equal to 800 ppm.

According to an embodiment of the present disclosure, the grain size of the sintered neodymium-iron-boron magnet is less than or equal to 8 μm.

The present disclosure further provides a preparation method for the sintered neodymium-iron-boron magnet described above, which comprises the following steps:
1) obtaining an R—Fe—Co—B—M alloy micro powder by strip casting-hydrogen decrepitation;
2) subjecting the R—Fe—Co—B—M alloy micro powder obtained in step 1) to jet milling to obtain a magnetic powder, and then pressing the magnetic powder into a pressed compact;
3) sintering the pressed compact obtained in step 2), optionally with or without an aging treatment, to obtain a sintered magnet;
4) processing the sintered magnet obtained in step 3) to a desired dimension, arranging a diffusion source on the surface of the processed product, then heating the product under a vacuum condition, introducing an inert gas when the temperature for heating raises to the temperature for a diffusion treatment, holding and then cooling to room temperature; and
5) subjecting the magnet after the diffusion treatment in step 4) to an aging treatment to give the sintered neodymium-iron-boron magnet.

According to an embodiment of the present disclosure, in step 1), the content of R is 26-35 wt %, the content of B is 0.8-1.3 wt %, the content of Co is 1.5-3.0 wt %, Mis one or more of Ga, Cu, Al, Zr, and Ti, wherein the content of Ga is 0.05-0.5 wt %, the content of Cu is 0.05-0.6 wt %, the content of Al is 0-1.5 wt %, the content of Zr is 0-0.5 wt %, and the content of Ti is 0-0.5 wt %, and the rest is iron and inevitable impurities.

According to an embodiment of the present disclosure, in step 1), R is a rare earth element, and illustratively, R is at least one of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), and scandium (Sc).

According to an embodiment of the present disclosure, in step 2), the magnetic powder has an average particle size of 2-5 μm.

According to an embodiment of the present disclosure, in step 2), the magnetic powder obtained by jet milling is mixed with 0.1-0.5 wt % of a lubricant with respect to the total mass of the magnetic powder obtained by jet milling for 0.1-3 h, and then pressed into a pressed compact at 20-40° C. in an orientation field having a magnetic field intensity of 1-5 T.

According to an embodiment of the present disclosure, in step 3), the pressed compact obtained in step 2) is sintered to obtain a sintered magnet; or the pressed compact obtained in step 2) is sintered and then subjected to an aging treatment to obtain a sintered magnet.

According to an embodiment of the present disclosure, in step 3), the sintered material is cooled to room temperature and then subjected to the aging treatment.

According to an embodiment of the present disclosure, in step 3), the sintering is performed at 900-1100° C. (e.g., 900° C., 950° C., 1000° C., 1050° C., or 1100° C.), and the sintering is performed for 2-10 h (e.g., 2 h, 3 h, 4 h, 5 h, 6 h, 7 h, 8 h, 9 h, or 10 h). The sintering is performed in a vacuum condition, and the vacuum degree is less than or equal to 20 Pa.

According to an embodiment of the present disclosure, in step 3), the aging treatment is a two-stage aging treatment, and the two-stage aging treatment comprises a first-stage aging treatment and a second-stage aging treatment, wherein the first-stage aging treatment is performed at 700-950° C. (e.g., 700° C., 750° C., 800° C., 850° C., 900° C., or 950° C.), and the first-stage aging treatment is performed for 1-12 h (e.g., 1 h, 2 h, 3 h, 4 h, 5 h, 6 h, 7 h, 8 h, 9 h, 10 h, 11 h, or 12 h); the second-stage aging treatment is performed at 400-600° C. (e.g., 400° C., 450° C., 500° C., 550° C., or 600° C.), and the second-stage aging treatment is performed for 1-12 h (e.g., 1 h, 2 h, 3 h, 4 h, 5 h, 6 h, 7 h, 8 h, 9 h, 10 h, 11 h, or 12 h).

According to an embodiment of the present disclosure, in step 3), the material after a first-stage aging treatment is cooled to room temperature and then subjected to a second-stage aging treatment. According to an embodiment of the present disclosure, in step 4), the diffusion source is a rare earth element source, e.g., at least one of a Dy source (e.g., metal Dy), a Tb source (e.g., metal Tb), a Ho source (e.g., metal Ho), a Nd source (e.g., metal Nd), and a Pr source (e.g., metal Pr).

According to an embodiment of the present disclosure, in step 4), the mass of the diffusion source is 0.2%-1.5% of the total mass of the sintered magnet, e.g., 0.2%, 0.3%, 0.4%, 0.5%, 0.6%, 0.7%, 0.8%, 0.9%, 1.0%, 1.1%, 1.2%, 1.3%, 1.4%, or 1.5%.

According to an embodiment of the present disclosure, in step 4), the method for the arranging may be at least one of a thermal spraying method, a coating method, a sputtering method, an impregnation method, and the like.

According to an embodiment of the present disclosure, in step 4), the vacuum degree of the vacuum condition is less than or equal to 20 Pa, e.g., 1-20 Pa, such as 1 Pa, 2 Pa, 5 Pa, 8 Pa, 10 Pa, 12 Pa, 15 Pa, 18 Pa, or 20 Pa.

According to an embodiment of the present disclosure, in step 4), the diffusion treatment is performed at 800-1000° C., e.g., 800° C., 850° C., 900° C., 950° C., or 1000° C.

According to an embodiment of the present disclosure, in step 4), an inert gas with a pressure of not less than 5 kPa is introduced when the temperature for heating raises to the temperature for a diffusion treatment; preferably, an inert gas with a pressure of 10-30 kPa, e.g., an inert gas with a pressure of 10 kPa, 15 kPa, 20 kPa, 25 kPa, or 30 kPa, is introduced.

According to an embodiment of the present disclosure, in step 4), the inert gas is, e.g., at least one of argon, helium, and nitrogen.

According to an embodiment of the present disclosure, in step 4), the holding is performed for not less than 3 h, e.g., 3-24 h, such as 3 h, 6 h, 8 h, 9 h, 10 h, 12 h, 15 h, 18 h, 20 h, 22 h, or 24 h.

According to an embodiment of the present disclosure, in step 4), the processed sintered magnet is further subjected to the steps of washing, degreasing, and acid washing.

According to an embodiment of the present disclosure, in step 5), the aging treatment is performed at 400-600° C. (e.g., 400° C., 450° C., 500° C., 550° C., or 600° C.), and the aging treatment is performed for 1-12 h (e.g., 1 h, 2 h, 3 h, 4 h, 5 h, 6 h, 7 h, 8 h, 9 h, 10 h, 11 h, or 12 h).

According to an embodiment of the present disclosure, the method comprises the following steps:
a) obtaining an R—Fe—Co—B—M alloy micro powder by strip casting-hydrogen decrepitation, wherein R is a rare earth element, the content of R is 26-35 wt %, the content of B is 0.8-1.3 wt %, the content of Co is 1.5-3.0 wt %, M is one or more of Ga, Cu, Al, Zr, and Ti, wherein the content of Ga is 0.05-0.5 wt %, the content of Cu is 0.05-0.6 wt %, the content of Al is 0-1.5 wt %, the content of Zr is 0-0.5 wt %, the content of Ti is 0-0.5 wt %, and the rest is iron and inevitable impurities;
b) subjecting the R—Fe—Co—B—M alloy micro powder obtained in step a) to jet milling to obtain a magnetic powder having an average particle size of 2-5 μm, adding 0.1-0.5 wt % of a lubricant with respect to the total mass of the magnetic powder obtained by jet milling into the magnetic powder obtained by jet milling and mixing for 0.1-3 h, and then pressing the magnetic powder into a pressed compact;
c) sintering the pressed compact obtained in step b) under a vacuum condition to obtain a sintered magnet, wherein the sintering is performed at 900-1100° C. for 2-10 h;
d) subjecting the sintered magnet obtained in step c) to a two-stage aging treatment, wherein a first-stage aging treatment is performed at 700-950° C., and a second-stage aging treatment is performed at 400-600° C.;
e) processing the magnet obtained in step c) or step d) to a desired dimension, and subjecting the processed product to washing, degreasing, and acid washing; arranging a diffusion source on the surface of the processed product, wherein the diffusion source is a rare earth element source, and the method for the arranging may be a thermal spraying method, a coating method, a sputtering method, or an impregnation method; and heating the product under a vacuum condition, introducing an inert gas when the temperature for heating raises to the temperature for a diffusion treatment, holding and then cooling to room temperature, wherein the diffusion treatment is performed at 800-1000° C., and the holding is performed for not less than 3 h; and
f) subjecting the magnet after the diffusion treatment in step e) to an aging treatment at 400-600° C.

### Beneficial Effects of the Present Disclosure

The present disclosure provides a sintered neodymium-iron-boron magnet having a high corrosion resistance and a high magnetic performance and a preparation method therefor. The sintered neodymium-iron-boron magnet comprises an element Co and comprises a main phase and a grain boundary phase, wherein the element Co is distributed in the grain boundary phase and the main phase of grains, and the sintered neodymium-iron-boron magnet satisfies the following formula: w1≥w2, wherein w1 is the content of the element Co distributed in the grain boundary phase of grains, and w2 is the content of the element Co distributed in the main phase of grains.

The sintered neodymium-iron-boron magnet mainly comprises a main phase and a grain boundary phase. An electrochemical corrosion will be caused due to the potential difference between the main phase and the grain boundary phase. Since the grain boundary phase is an Nd-rich phase, the grain boundary phase has much lower electrode potential and may undergo electrochemical corrosion first. Based on research, the inventors of the present disclosure have surprisingly found that by allowing the element Co to be concentrated in the grain boundary phase, the element Co can form an Nd₃Co phase with a Nd-rich phase. Due to the formation of the Nd₃Co phase, the electrode potential of the entire grain boundary phase is increased, the electrochemical corrosion is decreased, the amount of weight loss of the magnet is greatly reduced, the corrosion resistance of the neodymium-iron-boron magnet is significantly enhanced, and the magnetic performance of the neodymium-iron-boron magnet can be further significantly improved, thus achieving both good corrosion resistance and good magnetic performance of the neodymium-iron-boron magnet.

In the preparation method of the present disclosure, a sintered magnet is obtained through smelting, milling, pressing, and sintering treatment. The sintered magnet is processed to a desired dimension, then a diffusion source is arranged on the surface of the sintered magnet, then the sintered magnet is heated under a vacuum condition, an inert gas is introduced when the temperature for heating raises to the temperature for a diffusion treatment, and the sintered magnet is subjected to holding and then cooled to room temperature, thus obtaining a sintered neodymium-iron-boron magnet in which the content of element Co in the grain boundary phase of grains is greater than or equal to the content of element Co distributed in the main phase of grains. The inventors speculate that this may be because in the diffusion process under specific conditions, the diffusion source can enter the grain boundary phase, and the diffusion element entered the grain boundary phase can exchange with the element Co in the main phase, so that the element Co in the main phase migrates to the grain boundary phase.

### BRIEF DESCRIPTION OF THE DRAWINGS

FIG. 1 is an image showing the distribution of elements in the sintered neodymium-iron-boron magnet in Comparative Example 1 obtained by scanning with EPMA.

FIG. 2 is an image showing the distribution of elements in the sintered neodymium-iron-boron magnet in Example 1 obtained by scanning with EPMA.

FIG. 3 is an image showing the content change of element Co in the sintered neodymium-iron-boron magnet in Comparative Example 1 obtained by scanning with EPMA.

FIG. 4 is an image showing the content change of element Co in the sintered neodymium-iron-boron magnet in Example 1 obtained by scanning with EPMA.

FIG. 5 shows microstructure of the sintered neodymium-iron-boron magnet of the present disclosure.

FIG. 6 is a flowchart illustrating the preparation of the sintered neodymium-iron-boron magnet of the present disclosure.

### DETAILED DESCRIPTION

The present disclosure will be illustrated in further detail with reference to specific examples. It should be understood that the following examples are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the experimental methods used in the following examples are conventional methods. Unless otherwise stated, the reagents, materials and the like used in the following examples are commercially available.

### Example 1

(1) An alloy was prepared by subjecting NdPr, Dy, Co, Al, Fe, Cu, Ga, Ti, and ferroboron having at least 99% purity by weight to high-frequency melting in an argon atmosphere and pouring the resulting melt onto a quenching roller, with the alloy comprising 30.5% of NdPr, 0.5% of Dy, 1.5% of Co, 0.1% of Al, 0.2% of Cu, 0.2% of Ga, 0.18% of Ti, 0.98% of B and the rest of iron and inevitable impurities by mass percentage. The alloy was subjected to hydrogen decrepitation to obtain a coarse powder, and then the coarse powder was subjected to jet milling to obtain a magnetic powder having a particle size D50 of 4.0 μm. The powder obtained by jet milling described above was added with 0.3 wt % of a lubricant with respect to the total mass of the powder obtained by jet milling, mixed for 2 h, and then was pressed into a pressed compact at room temperature in an orientation field having a magnetic field intensity of 2 T. Then, the pressed compact was put into a vacuum sintering furnace and sintered at 1070° C. for 6 h. After the holding was finished, the blank was cooled to room temperature, heated to 900° C., and then subjected to a first-stage aging treatment at 900° C. for 3 h. After the holding was finished, the blank was cooled to room temperature, heated to 520° C., and then subjected to a second-stage aging treatment at 520° C. for 5 h. The blank was cooled and taken out from the furnace, thus obtaining a neodymium-iron-boron magnet.

(2) The magnet was processed into a rectangle piece with a dimension of 25-15-5 mm. The rectangle piece was degreased and acid washed and then subjected to a diffusion treatment with Tb under a vacuum condition (<20 Pa) at a temperature of 900° C. When the temperature reached 900° C., argon with a pressure of 15 kPa was introduced, and held for 3 h. Afterwards, the piece was cooled to room temperature, heated to 480° C., and then subjected to an aging treatment at 480° C. for 3 h. The diffused amount of Tb was 0.6 wt % of the total mass of the rectangle piece with a dimension of 25-15-5 mm. The diffusion source (metal Tb) in this example was arranged by a thermal spraying method, and the product after the diffusion treatment was referred to as Al. The product was subjected to a magnetic performance test and a weight loss test. The weight loss test was performed under the following conditions: a temperature of 121° C., a humidity of 100%, a pressure of 2.0 Bar, and a duration of 4 days.

### Comparative Example 1

This comparative example differed from Example 1 only in that 1.0% of Co was added in step (1). In step (2), the product after the diffusion treatment was referred to as B1.

TABLE 1
Magnetic performance and corrosion resistance of A1 and B1

| | Br (T) | Hcj (kA/m) | Amount of weight loss (mg/cm²) |
|---|---|---|---|
| A1 | 1.390 | 2180 | 0.11 |
| B1 | 1.386 | 2166 | 4.5 |

As can be seen from Table 1, the performance of the product of Example 1 is comparable to that of Comparative Example 1, but the product of Example 1 has less weight loss and better comprehensive performance.

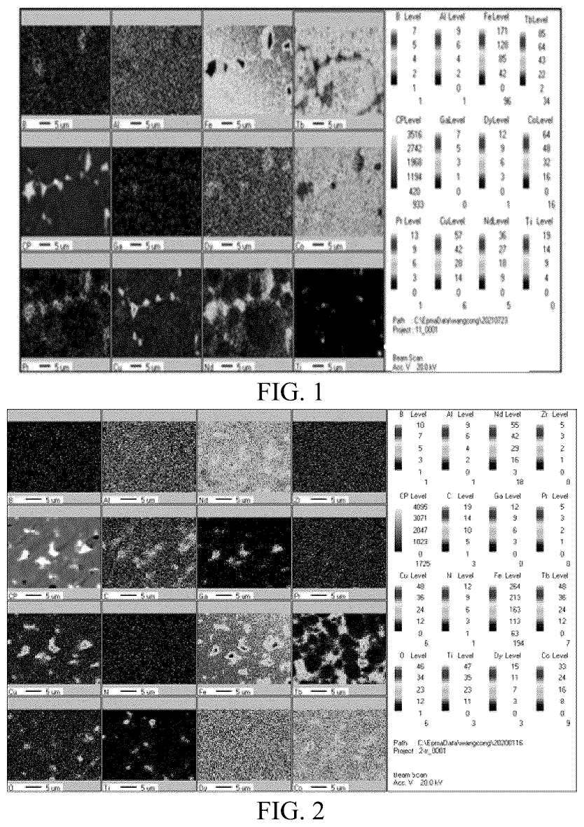

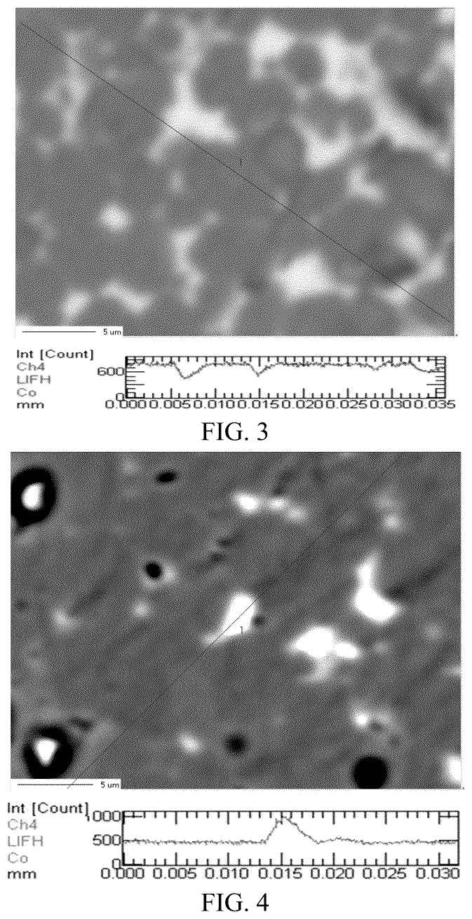

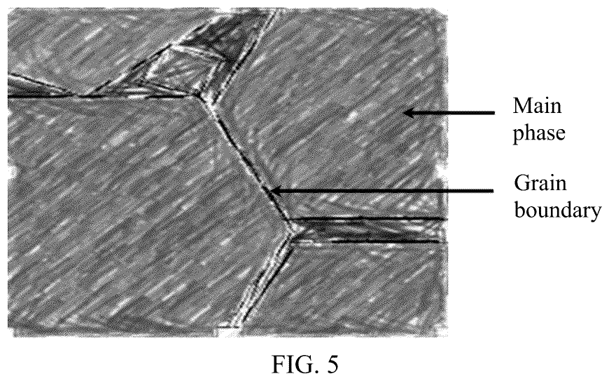

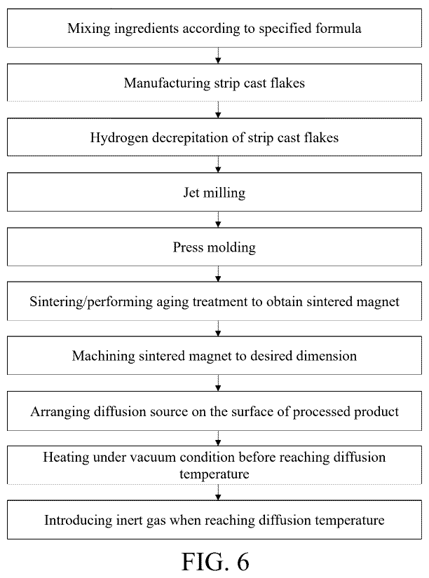

Further, the product A1 of Example 1 and the product B1 of Comparative Example 1 were processed into a product with a dimension of 10-10-5 mm respectively, wherein the magnetizing direction of the product is along the length of 5 mm. The product was ground off by 0.05 mm along the magnetizing direction and polished, and then the large surface of 10-10 mm was scanned with EPMA. The structure and composition of the main phase and the grain boundary phase were observed by scanning. FIG. 1 is an image showing the distribution of elements in the sintered neodymium-iron-boron magnet in Comparative Example 1 obtained by scanning with EPMA. FIG. 2 is an image showing the distribution of elements in the sintered neodymium-iron-boron magnet in Example 1 obtained by scanning with EPMA. FIG. 3 is an image showing the content change of element Co in the sintered neodymium-iron-boron magnet in Comparative Example 1 obtained by scanning with EPMA. FIG. 4 is an image showing the content change of element Co in the sintered neodymium-iron-boron magnet in Example 1 obtained by scanning with EPMA.

As can be seen from FIG. 1 and FIG. 3, the element Co is distributed in the grain boundary phase and the main phase of grains, and the content of the element Co distributed in the grain boundary phase of grains is less than the content of the element Co distributed in the main phase of grains. As can be seen from FIG. 2 and FIG. 4, the element Co is also distributed in the grain boundary phase and the main phase of grains, but the content of the element Co distributed in the grain boundary phase of grains is more than the content of the element Co distributed in the main phase of grains. In addition, the content of the element Co in the grain boundary phase is about twice that in the main phase of grains.

TABLE 2
Content of element Co in sintered neodymium-iron-boron magnet

| | | The content of element Co after |
|---|---|---|
| | | grinding off by 0.05 mm along the |
| Element | | magnetizing direction |
| Example 1 | Main phase | 1.11 wt % |
| | Grain boundary phase | 2.23 wt % |
| Comparative | Main phase | 1.06 wt % |
| Example 1 | Grain boundary phase | 0.93 wt % |

In summary, based on the comparison between Example 1 and Comparative Example 1, it can be seen that when the content of the element Co is not in a range of 1.5-3.0 wt %, the sintered neodymium-iron-boron magnet having the special grain boundary structure of the present disclosure cannot be generated, and the corrosion resistance of the sintered neodymium-iron-boron magnet can be ensured only if sufficient amount of the element Co is distributed in the grain boundary phase of grains of the sintered neodymium-iron-boron magnet.

### Example 2

(1) An alloy was prepared by subjecting NdPr, Co, Al, Fe, Cu, Ga, Ti, and ferroboron having at least 99% purity by weight to high-frequency melting in an argon atmosphere and pouring the resulting melt onto a quenching roller, with the alloy comprising 30.8% of NdPr, 1.5% of Co, 0.2% of Al, 0.15% of Cu, 0.15% of Ga, 0.2% of Ti, 0.98% of B and the rest of iron and inevitable impurities by mass percentage. The alloy was subjected to hydrogen decrepitation to obtain a coarse powder, and then the coarse powder was subjected to jet milling to obtain a magnetic powder with a particle size D50 of 3.7 μm. The powder obtained by jet milling described above was added with 0.4 wt % of a lubricant with respect to the total mass of the powder obtained by jet milling, mixed for 2 h, and then was pressed into a pressed compact at room temperature in an orientation field having a magnetic field intensity of 2 T. Then, the pressed compact was put into a vacuum sintering furnace and sintered at 1065° C. for 6 h. After the holding was finished, the blank was cooled to room temperature, heated to 800° C., and then subjected to a first-stage aging treatment at 800° C. for 3 h. After the holding was finished, the blank was cooled to room temperature, heated to 500° C., and then subjected to a second-stage aging treatment at 500° C. for 5 h. The blank was cooled and taken out from the furnace, thus obtaining a neodymium-iron-boron magnet.

(2) The magnet was processed into a rectangle piece with a dimension of 25-15-2.5 mm, and the rectangle piece was degreased and acid washed and then subjected to a diffusion treatment using Dy under a vacuum condition (<20 Pa) at a temperature of 880° C. When the temperature reached 880° C., argon with a pressure of 20 kPa was introduced, and holding was performed for 3 h. Afterwards, the rectangle piece was cooled to room temperature, heated to 500° C., and then subjected to an aging treatment at 500° C. for 3 h. The diffused amount of Dy was 0.8 wt % of the total mass of the rectangle piece with a dimension of 25-15-2.5 mm. The diffusion source (metal Dy) in this example was arranged by a coating method, and the product after the diffusion treatment was referred to as A2. The product was subjected to a magnetic performance test and a weight loss test. The weight loss test was performed under the following conditions: a temperature of 121° C., a humidity of 100%, a pressure of 2.0 Bar, and a duration of 4 days.

### Comparative Example 2

This comparative example differed from Example 2 only in that 3.5% of Co was added in step (1). In step (2), the product after the diffusion treatment was referred to as B2.

TABLE 3
Magnetic performance and corrosion resistance of A2 and B2

| | Br (T) | Hcj (kA/m) | Amount of weight loss (mg/cm²) |
|---|---|---|---|
| A2 | 1.395 | 1900 | 0.22 |
| B2 | 1.384 | 1786 | 0.13 |

As can be seen from Table 3, the amount of weight loss of the product of Example 2 is comparable to that of Comparative Example 2, but the product of Example 2 has higher magnetic performance. This is mainly because it can be ensured that the grain boundary phases of the magnets prepared by the methods of Example 2 and Comparative Example 2 have sufficient distribution of element Co and thereby the corrosion resistance of the products is increased. However, too much Co is added in Comparative Example 2, which affects the magnetic performance of the magnet and causes a decrease in the comprehensive performance of the product.

### Example 3

(1) An alloy was prepared by subjecting Nd, Co, Al, Fe, Cu, Ga, Zr, and ferroboron having at least 99% purity by weight to high-frequency melting in an argon atmosphere and pouring the resulting melt onto a quenching roller, with the alloy comprising 31.5% of Nd, 1.8% of Co, 0.15% of Al, 0.10% of Cu, 0.15% of Ga, 0.15% of Zr, 0.98% of B and the rest of iron and inevitable impurities by mass percentage. The alloy was subjected hydrogen decrepitation to obtain a coarse powder, and then the coarse powder was subjected to jet milling to obtain a magnetic powder with a particle size D50 of 4.8 μm. The powder obtained by jet milling described above was added with 0.2 wt % of a lubricant with respect to the total mass of the powder obtained by jet milling, mixed for 2 h, and then was pressed into a pressed compact at room temperature in an orientation field having a magnetic field intensity of 2 T. Then, the pressed compact was put into a vacuum sintering furnace and sintered at 1085° C. for 6 h. After the holding was finished, the blank was cooled to room temperature, heated to 900° C., and then subjected to a first-stage aging treatment at 900° C. for 3 h. After the holding was finished, the blank was cooled to room temperature, heated to 480° C., and then subjected to a second-stage aging treatment at 480° C. for 5 h. The blank was cooled and taken out from the furnace, thus obtaining a neodymium-iron-boron magnet.

(2) The magnet was processed into a rectangle piece with a dimension of 40-10-4 mm, and the rectangle piece was degreased and acid washed and then subjected to a diffusion treatment using Tb under a vacuum condition (<20 Pa) at a temperature of 920° C. When the temperature reached 920° C., argon with a pressure of 25 kPa was introduced, and holding was performed for 3 h. Afterwards, the rectangle piece was cooled to room temperature, heated to 510° C., and then subjected to an aging treatment at 510° C. for 3 h. The diffused amount of Tb was 0.8 wt % of the total mass of the rectangle piece with a dimension of 40-10-4 mm. The diffusion source (metal Tb) in this example was arranged by a coating method, and the product after the diffusion treatment was referred to as A3. The product was subjected to a magnetic performance test and a weight loss test. The weight loss test was performed under the following conditions: a temperature of 121° C., a humidity of 100%, a pressure of 2.0 Bar, and a duration of 4 days.

### Comparative Example 3

This comparative example differed from Example 3 only in that the magnetic performance test and the weight loss test were performed for the neodymium-iron-boron magnet B3 obtained after cooling and taking out from the furnace (i.e. without a diffusion treatment) in step (1).

TABLE 4
Magnetic performance and corrosion resistance of A3 and B3

| | Br (T) | Hcj (kA/m) | Amount of weight loss (mg/cm²) |
|---|---|---|---|
| A3 | 1.410 | 1982 | 0.25 |
| B3 | 1.435 | 1060 | 2.83 |

As can be seen from Table 4, compared with Comparative Example 3, the product of Example 3 has better corrosion resistance and magnetic performance. Although the same amount of element Co is added during smelting in both Example 3 and Comparative Example 3, the product of Comparative Example 3, without undergoing the method of the present disclosure, can not ensure sufficient distribution of element Co in the grain boundary phase, thus affecting the corrosion resistance of the product. Due to being subjected to a diffusion treatment, the magnetic performance of the magnet of Example 3 was further improved.

### Example 4-1

(1) An alloy was prepared by subjecting Nd, Co, Al, Fe, Cu, Ga, Ti, and ferroboron having at least 99% purity by weight to high-frequency melting in an argon atmosphere and pouring the resulting melt onto a quenching roller, with the alloy comprising 32% of Nd, 1.5% of Co, 0.35% of A1, 0.15% of Cu, 0.10% of Ga, 0.15% of Ti, 0.98% of B and the rest of iron and inevitable impurities by mass percentage. The alloy was subjected hydrogen decrepitation to obtain a coarse powder, and then the coarse powder was subjected to jet milling to obtain a magnetic powder with a particle size D50 of 4.5 μm. The powder obtained by jet milling described above was added with 0.4 wt % of a lubricant with respect to the total mass of the powder obtained by jet milling, mixed for 2 h, and then was pressed into a pressed compact at room temperature in an orientation field having a magnetic field intensity of 2 T. Then, the pressed compact was put into a vacuum sintering furnace and sintered at 1080° C. for 6 h. After the holding was finished, the blank was cooled to room temperature, heated to 850° C., and then subjected to a first-stage aging treatment at 850° C. for 3 h. After the holding was finished, the blank was cooled to room temperature, heated to 510° C., and then subjected to a second-stage aging treatment at 510° C. for 5 h. The blank was cooled and taken out from the furnace, thus obtaining a neodymium-iron-boron magnet.

(2) The magnet was processed into a rectangle piece with a dimension of 38-23-6 mm, and the rectangle piece was degreased and acid washed and then subjected to a diffusion treatment using Dy under a vacuum condition (<20 Pa) at a temperature of 890° C. When the temperature reached 890° C., argon with a pressure of 30 kPa was introduced, and holding was performed for 3 h. Afterwards, the rectangle piece was cooled to room temperature, heated to 550° C., and then subjected to an aging treatment at 550° C. for 3 h. The diffused amount of Dy was 0.7 wt % of the total mass of the rectangle piece with a dimension of 38-23-6 mm. The diffusion source (metal Dy) in this example was arranged by an impregnation method, and the product after the diffusion treatment was referred to as A4-1. The product was subjected to a magnetic performance test and a weight loss test. The weight loss test was performed under the following conditions: a temperature of 121° C., a humidity of 100%, a pressure of 2.0 Bar, and a duration of 4 days.

### Example 4-2

This comparative example differed from Example 4-1 only in step (2) and other steps remained unchanged:

(2) The magnet was processed into a rectangle piece with a dimension of 38-23-6 mm, and the rectangle piece was degreased and acid washed and then subjected to a diffusion treatment using Dy under a vacuum condition (<20 Pa) at a temperature of 890° C. When the temperature reached 890° C., argon with a pressure of 5 kPa was introduced, and holding was performed for 3 h. Afterwards, the rectangle piece was cooled to room temperature, heated to 550° C., and then subjected to an aging treatment at 550° C. for 3 h. The diffused amount of Dy was 0.7 wt % of the total mass of the rectangle piece with a dimension of 38-23-6 mm. The diffusion source (metal Dy) in this example was arranged by an impregnation method, and the product after the diffusion treatment was referred to as A4-2. The product was subjected to a magnetic performance test and a weight loss test. The weight loss test was performed under the following conditions: a temperature of 121° C., a humidity of 100%, a pressure of 2.0 Bar, and a duration of 4 days.

### Comparative Example 4

This comparative example differed from Example 4-1 only in step (2) and other steps remained unchanged:

(2) The magnet was processed into a rectangle piece with a dimension of 38-23-6 mm, and the rectangle piece was degreased and acid washed and then subjected to a diffusion treatment using Dy under a vacuum condition (<20 Pa) at a temperature of 890° C. When the temperature reached 890° C., holding was performed for 3 h. Afterwards, the rectangle piece was cooled and then subjected to an aging treatment at 550° C. for 3 h. The diffused amount of Dy was 0.7 wt % of the total mass of the rectangle piece with a dimension of 38-23-6 mm. The diffusion source (metal Dy) in this comparative example was arranged by an impregnation method, and the product after the diffusion treatment was referred to as B4. The product was subjected to a magnetic performance test and a weight loss test. The weight loss test was performed under the following conditions: a temperature of 121° C., a humidity of 100%, a pressure of 2.0 Bar, and a duration of 4 days.

TABLE 5
Magnetic performance and corrosion
resistance of A4-1, A4-2, and B4

| | Br (T) | Hcj (kA/m) | Amount of weight loss (mg/cm²) |
|---|---|---|---|
| A4-1 | 1.373 | 1760 | 0.09 |
| A4-2 | 1.375 | 1720 | 1.23 |
| B4 | 1.377 | 1677 | 1.76 |

The product A4-1 of Example 4-1, the product A4-2 of Example 4-2, and the product B4 of Comparative Example 4 were processed into a product with a dimension of 10-10-6 mm respectively, wherein the magnetizing direction of the product was along the length of 6 mm. The product was ground off by 0.2 mm along the magnetizing direction and polished, and then the large surface of 10-10 mm was scanned with EPMA. The structure and composition of the main phase and the grain boundary phase were observed by scanning, and the test results are shown in Table 6.

TABLE 6
Content of element Co in sintered neodymium-iron-boron magnet

| | | The content of Co after grinding |
|---|---|---|
| | | off by 0.2 mm along the |
| Element | | magnetizing direction |
| Example 4-1 | Main phase | 1.08 wt % |
| | Grain boundary phase | 2.31 wt % |
| Example 4-2 | Main phase | 1.30 wt % |
| | Grain boundary phase | 1.76 wt % |
| Comparative | Main phase | 1.50 wt % |
| Example 4 | Grain boundary phase | 1.38 wt % |

As can be seen from Table 5 and Table 6, comparing Example 4-1 with Example 4-2, when the sintered neodymium-iron-boron magnet meets the formula of w1≥w2, the corrosion resistance of the product can be improved. However, the product of Example 4-1 has higher magnetic performance and better corrosion resistance. This is mainly because the magnet prepared by the method of Example 4-1 has sufficient distribution of element Co in the grain boundary phase and a sintered neodymium-iron-boron magnet satisfying the formula of w1≥1.5×w2 can be obtained, thereby effectively improving the corrosion resistance of the product. Meanwhile, the diffusion process of the heavy rare earth is ensured, so that the magnetic performance of the product is higher. The magnet prepared by the method of Example 4-2 also has distribution of element Co in the grain boundary phase, but the method of Example 4-2 cannot ensure that the grain boundary phase has sufficient distribution of element Co (i.e. it cannot satisfy w1≥1.5×w2), resulting in insufficient improvement in the corrosion resistance of the product. In Comparative Example 4, the diffusion is performed directly without introducing argon, so a product enriched with Co element in the grain boundary phase can not be obtained. Further, based on the comparison between Example 4-1, Example 4-2, and Comparative Example 4, it can be seen that during a diffusion process, when argon is introduced, it is possible to achieve and obtain a product enriched with Co in the grain boundary phase and satisfying the formula of w1≥w2. When argon with a pressure of greater than or equal to 10 kPa is introduced, it is possible to achieve and obtain a product enriched with Co in the grain boundary phase and satisfying the formula of w1≥1.5×w2. It was found that a magnet which satisfies the formula of w1≥1.5×w2 has higher magnetic performance and better corrosion resistance.

### Comparative Example 5-1

(1) An alloy was prepared by subjecting NdPr, Dy, Co, Al, Fe, Cu, Ga, Ti, and ferroboron having at least 99% purity by weight to high-frequency melting in an argon atmosphere and pouring the resulting melt onto a quenching roller, with the alloy comprising 29% of NdPr, 2.5% of Dy, 1.0% of Co, 0.2% of Al, 0.20% of Cu, 0.15% of Ga, 0.18% of Ti, 0.96% of B and the rest of iron and inevitable impurities by mass percentage. The alloy was subjected hydrogen decrepitation to obtain a coarse powder, and then the coarse powder was subjected to jet milling to obtain a magnetic powder with a particle size D50 of 4.2 μm. The powder obtained by jet milling described above was added with 0.2 wt % of a lubricant with respect to the total mass of the powder obtained by jet milling, mixed for 2 h, and then was pressed into a pressed compact at room temperature in an orientation field having a magnetic field intensity of 2 T. Then, the pressed compact was put into a vacuum sintering furnace and sintered at 1060° C. for 6 h. After the holding was finished, the blank was cooled to room temperature, heated to 900° C., and then subjected to a first-stage aging treatment at 900° C. for 3 h. After the holding was finished, the blank was cooled to room temperature, heated to 500° C., and then subjected to a second-stage aging treatment at 500° C. for 5 h. The blank was cooled and taken out from the furnace, thus obtaining a neodymium-iron-boron magnet.

(2) The magnet was processed into a rectangle piece with a dimension of 41-18-1.8 mm, and the rectangle piece was degreased and acid washed and then subjected to a diffusion treatment using Tb under a vacuum condition (<20 Pa) at a temperature of 940° C. When the temperature reached 940° C., argon with a pressure of 10 kPa was introduced, and holding was performed for 3 h. Afterwards, the rectangle piece was cooled to room temperature, heated to 490° C., and then subjected to an aging treatment at 490° C. for 3 h. The diffused amount of Tb was 1.0 wt % of the total mass of the rectangle piece with a dimension of 41-18-1.8 mm. The diffusion source (metal Tb) in this example was arranged by a sputtering method, and the product after the diffusion treatment was referred to as B5-1. The product was subjected to a magnetic performance test and a weight loss test. The weight loss test was performed under the following conditions: a temperature of 121° C., a humidity of 100%, a pressure of 2.0 Bar, and a duration of 4 days.

### Comparative Example 5-2

This comparative example differed from Comparative Example 5-1 only in step (2) and other steps remained unchanged:

(2) The magnet was processed into a rectangle piece with a dimension of 41-18-1.8 mm, and the rectangle piece was degreased and acid washed and then subjected to a diffusion treatment using Tb under a vacuum condition (<20 Pa) at a temperature of 940° C. When the temperature reached 940° C., holding was performed for 3 h. Afterwards, the rectangle piece was cooled to room temperature, heated to 490° C., and then subjected to an aging treatment at 490° C. for 3 h. The diffused amount of Tb was 1.0 wt % of the total mass of the rectangle piece with a dimension of 41-18-1.8 mm, and the diffusion source (metal Tb) in this example was arranged by a sputtering method, and the product after the diffusion treatment was referred to as B5-2. The product was subjected to a magnetic performance test and a weight loss test. The weight loss test was performed under the following conditions: a temperature of 121° C., a humidity of 100%, a pressure of 2.0 Bar, and a duration of 4 days.

TABLE 7
Magnetic performance and corrosion resistance of B5-1 and B5-2

| | Br (T) | Hcj (kA/m) | Amount of weight loss (mg/cm²) |
|---|---|---|---|
| B5-1 | 1.320 | 2502 | 3.27 |
| B5-2 | 1.323 | 2479 | 3.66 |

As can be seen from Table 7, comparing Comparative Example 5-1 with Comparative Example 5-2, it is found that the products of both comparative examples have poor corrosion resistance, which is mainly because the content of the element Co added during smelting is low, and the sufficient distribution of element Co in the grain boundary phase cannot be ensured, thereby affecting the corrosion resistance of the product. In addition, in the method of Comparative Example 5-2, the distribution of element Co in the grain boundary phase is further reduced, resulting in further deterioration of the corrosion resistance of the product.

The above examples illustrate the embodiments of the present disclosure. However, the present disclosure is not limited to the embodiments described above. Any modification, equivalent replacement, improvement, and the like made without departing from the spirit and principle of the present disclosure shall fall within the protection scope of the present disclosure.

1. A sintered neodymium-iron-boron magnet, comprising an element Co with a content of 1.5-3.0 wt % and comprising a main phase and a grain boundary phase, wherein the element Co is distributed in the grain boundary phase and the main phase of grains, and the sintered neodymium-iron-boron magnet satisfies the following formula: w1≥w2, wherein w1 is the content of the element Co distributed in the grain boundary phase of grains, and w2 is the content of the element Co distributed in the main phase of grains.

2. The sintered neodymium-iron-boron magnet according to claim 1, wherein the sintered neodymium-iron-boron magnet satisfies the following formula: w1≥1.5×w2, wherein w1 is the content of the element Co distributed in the grain boundary phase of grains, and w2 is the content of the element Co distributed in the main phase of grains.

3. The sintered neodymium-iron-boron magnet according to claim 1, wherein in the sintered neodymium-iron-boron magnet, a Co-rich region in the grain boundary phase does not completely overlap with a region enriched in heavy rare earths; and/or
in the sintered neodymium-iron-boron magnet, a Co-rich region in the grain boundary phase is a Fe-poor region; and/or
in the sintered neodymium-iron-boron magnet, the grain boundary phase contains a phase consisting of RFeCOM, wherein R is a rare earth element, Fe is iron, Co is cobalt, and M is one or more of Ga, Cu, Al, Zr, and Ti; and/or
in the sintered neodymium-iron-boron magnet, the content of the R element in the grain boundary phase is greater than or equal to the content of the R element in the main phase; and/or
in the sintered neodymium-iron-boron magnet, the content of the M element in the grain boundary phase is greater than or equal to the content of the M element in the main phase; and/or
in the sintered neodymium-iron-boron magnet, the content of the Fe element in the grain boundary phase is less than or equal to the content of the Fe element in the main phase.

4. The sintered neodymium-iron-boron magnet according to claim 1, wherein the sintered neodymium-iron-boron magnet has a chemical formula of RFeCoBM, wherein R is a rare earth element, Fe is iron, B is boron, and M is one or more of Ga, Cu, Al, Zr, and Ti, wherein the content of R is 26-35 wt %, the content of B is 0.8-1.3 wt %, the content of Co is 1.5-3.0 wt %, the content of Ga is 0.05-0.5 wt %, the content of Cu is 0.05-0.6 wt %, the content of Al is 0-1.5 wt %, the content of Zr is 0-0.5 wt %, the content of Ti is 0-0.5 wt %, and the rest is iron and inevitable impurities.

5. A preparation method for the sintered neodymium-iron-boron magnet according to claim 1, comprising the following steps:
1) obtaining an R—Fe—Co—B—M alloy micro powder by strip casting-hydrogen decrepitation;
2) subjecting the R—Fe—Co—B—M alloy micro powder obtained in step 1) to jet milling to obtain a magnetic powder, and then pressing the magnetic powder into a pressed compact;
3) sintering the pressed compact obtained in step 2), optionally with or without an aging treatment, to obtain a sintered magnet;
4) processing the sintered magnet obtained in step 3) to a desired dimension, arranging a diffusion source on the surface of the processed product, then heating the product under a vacuum condition, introducing an inert gas when the temperature for heating raises to the temperature for a diffusion treatment, holding and then cooling to room temperature; and
5) subjecting the magnet after the diffusion treatment in step 4) to an aging treatment to give the sintered neodymium-iron-boron magnet.

6. The preparation method according to claim 5, wherein in step 2), the magnetic powder obtained by jet milling is mixed with 0.1-0.5 wt % of a lubricant with respect to the total mass of the magnetic powder obtained by jet milling for 0.1-3 h, and then pressed into a pressed compact at 20-40° C. in an orientation field having a magnetic field intensity of 1-5 T.

7. The preparation method according to claim 5, wherein in step 3), the sintering is performed at 900-1100° C., and the sintering is performed for 2-10 h; and/or
in step 3), the aging treatment is a two-stage aging treatment, and the two-stage aging treatment comprises a first-stage aging treatment and a second-stage aging treatment, wherein the first-stage aging treatment is performed at 700-950° C., and the first-stage aging treatment is performed for 1-12 h; the second-stage aging treatment is performed at 400-600° C., and the second-stage aging treatment is performed for 1-12 h.

8. The preparation method according to claim 5, wherein in step 4), the diffusion source is at least one of rare earth element sources; and/or
in step 4), an inert gas with a pressure of not less than 5 kPa, such as an inert gas with a pressure of 10-30 kPa, is introduced.

9. The preparation method according to claim 5, wherein in step 4), the vacuum degree of the vacuum condition is less than or equal to 20 Pa; and/or
in step 4), the diffusion treatment is performed at 800-1000° C.; and/or
in step 4), the holding is performed for not less than 3 h.

10. The preparation method according to claim 5, wherein in step 5), the aging treatment is performed at 400-600° C.
